(19) United States
(12) Patent Application Publication
(10) Pub. No.: US 2019/0043402 A1
(43) Pub. Date: Feb. 7, 2019

(54) METHODS FOR MANUFACTURING A FLEXIBLE TOUCH SENSOR, FLEXIBLE TOUCH SENSORS AND DISPLAY SCREENS

(71) Applicants: BOE TECHNOLOGY GROUP CO., LTD., Beijing (CN); HEFEI XINSHENG OPTOELECTRONICS TECHNOLOGY CO., LTD, Hefei (CN)

(72) Inventors: Ting Zeng, Beijing (CN); Ming Zhang, Beijing (CN); Hongjun Li, Beijing (CN); Qicheng Chen, Beijing (CN); Youting Zhang, Beijing (CN); Liuyue Yin, Beijing (CN)

(21) Appl. No.: 15/956,706

(22) Filed: Apr. 18, 2018

(30) Foreign Application Priority Data
Aug. 3, 2017 (CN) 201710657760.3

(51) Int. Cl. G09G 3/20; G06F 3/041

(52) U.S. Cl. CPC G09G 3/20; G06F 3/0412; B32B 2307/202; G06F 2203/04102; B32B 2307/412; G06F 2203/04103

(57) ABSTRACT

A method for manufacturing a flexible touch sensor, a flexible touch sensor and a display screen are disclosed. The method comprises forming a flexible film on a substrate; forming a first transparent conductive layer on the flexible film; and patterning the first transparent conductive layer to form a plurality of first electrodes and a plurality of second electrodes intersecting therewith within a display area of the flexible touch sensor. The first transparent conductive layer is composed of multiple layers of first transparent conductive films which are formed by multiple depositions.

### CROSS-REFERENCE TO RELATED APPLICATION(S)

This application claims priority to the Chinese Patent Application No. 201710657760.3, filed on Aug. 3, 2017, which is incorporated herein by reference in its entirety.

### TECHNICAL FIELD

The present disclosure relates to the field of display technology, and more particularly, to a method for manufacturing a flexible touch sensor, a flexible touch sensor, and a display screen including the flexible touch sensor.

### BACKGROUND

With the gradual development of flexible touch display products with a narrow frame or flexible touch display products without a frame, a space of wiring for a flexible touch electrode (i.e., a sensor) at an edge of a frame will be further reduced, which requires a process of manufacturing the sensor to realize a lower channel impedance in a display area (i.e., a pattern area), so as to reduce a surface resistance (often referred to as a square resistance). A label of the square resistance is Rs, which may be expressed as Rs=ρ/t, where ρ is resistivity of a material of the electrode and t is a thickness of the electrode.

### SUMMARY

According to a first aspect of the embodiments of the present disclosure, there is provided a method for manufacturing a flexible touch sensor, comprising:

forming a flexible film on a substrate;

forming a first transparent conductive layer on the flexible film; and

patterning the first transparent conductive layer to form a plurality of first electrodes and a plurality of second electrodes intersecting therewith within a display area of the flexible touch sensor,

wherein the first transparent conductive layer is composed of multiple layers of first transparent conductive films which are formed by deposition many times.

In an embodiment, a first layer of first transparent conductive film in the multiple layers of first transparent conductive films has a thickness of 15-45 nm, and the multiple layers of first transparent conductive films has a total thickness of 120-200 nm.

In an embodiment, the first transparent conductive layer is composed of two layers of first transparent conductive films which are formed by depositions twice, wherein a first layer of first transparent conductive film in the two layers of first transparent conductive films has a thickness of 15-45 nm, and a second layer of first transparent conductive film in the two layers of first transparent conductive films has a thickness of 90-120 nm.

In an embodiment, the first transparent conductive layer is composed of three layers of first transparent conductive films which are formed by deposition three times, wherein each layer of first transparent conductive film in the three layers of first transparent conductive films has a thickness of 45 nm.

In an embodiment, before forming a flexible film on a substrate, the method further comprises:

applying adhesive to the substrate;

heating the adhesive to remove organic solvent components in the adhesive; and

cooling the heated adhesive.

In an embodiment, forming a flexible film on a substrate comprises:

affixing the flexible film to the adhesive.

In an embodiment, the heating process is performed at a temperature of 150-200° C. for 30-60 min.

In an embodiment, before forming a first transparent conductive layer on the flexible film, the method further comprises:

forming an index margin on a surface of the flexible film;

wherein, the first transparent conductive layer is formed on the index margin.

In an embodiment, forming the first transparent conductive layer on the flexible film comprises forming the first transparent conductive layer on the index margin.

In an embodiment, the flexible touch sensor has reflectivity less than 12% in a visible light area.

In an embodiment, the index margin has a refractive index of 1.65 and a thickness of 40-50 nm.

In an embodiment, the index margin comprises a first optical layer and a second optical layer, wherein the first optical layer has a refractive index of 1.65 and a thickness of 40-50 nm, and the second optical layer has a refractive index of 1.49 and a thickness of 160-200 nm.

In an embodiment, the method further comprises:

forming first metal traces connected to the first electrodes and second metal traces connected to the second electrodes outside the display area;

forming a first over coat on the first electrodes, the second electrodes, the first metal traces and the second metal traces, wherein via holes through which the second electrodes are exposed are formed on the first over coat; and

forming transparent bridge electrodes connected to the second electrodes at the via holes of the first over coat.

In an embodiment, the first over coat is formed at a temperature of 90-130° C.

In an embodiment, forming a transparent bridge electrode comprises forming a second transparent conductive layer on the first over coat, and patterning the second transparent conductive layer to form the transparent bridge electrodes connected to the second electrodes at the via holes,

wherein the second transparent conductive layer is composed of multiple layers of second transparent conductive films which are formed by deposition many times, and a first layer of second transparent conductive film in the multiple layers of second transparent conductive films has a thickness of 15-45 nm, and the multiple layers of second transparent conductive films has a total thickness less than 200 nm.

In an embodiment, the second transparent conductive layer is composed of two layers of second transparent conductive films which are formed by deposition twice, wherein a first layer of second transparent conductive film in the two layers of second transparent conductive films has a thickness of 15-45 nm, and a second layer of second transparent conductive film in the two layers of second transparent conductive films has a thickness of 90-120 nm.

In an embodiment, the second transparent conductive layer is composed of three layers of second transparent conductive films which are formed by deposition three times, wherein each layer of second transparent conductive film in the three layers of second transparent conductive films has a thickness of 45 nm.

In an embodiment, the method further comprises: forming a second over coat on the transparent bridge electrode, wherein the second over coat is formed at a temperature of 90-130° C.

According to another aspect of the embodiments of the present disclosure, there is provided a flexible touch sensor, wherein the flexible touch sensor is manufactured using the method described above.

According to yet another aspect of the embodiments of the present disclosure, there is provided a display screen comprising a display panel and the flexible touch sensor described above which is provided on a display side of the display panel.

### BRIEF DESCRIPTION OF THE DRAWINGS

In order to more clearly describe the technical solutions in the embodiments of the present disclosure or in the related art, the accompanying drawings used in the description of the embodiments or the related art will be briefly described below. Obviously, the accompanying drawings in the following description are only some embodiments of the present disclosure, and other accompanying drawings can also be obtained by those of ordinary skill in the art based on these accompanying drawings without any creative work. In the accompanying drawings:

FIG. 1(a) is a first photograph with a bubbling defect after an Over Coat (OC for short) is formed on Indium Tin Oxide (ITO) in the related art;

FIG. 1(b) is a second photograph with a bubbling defect after an OC is formed on ITO in the related art;

FIG. 2 is a schematic flowchart of a method for manufacturing a flexible touch sensor according to an embodiment of the present disclosure;

FIG. 3 is a scanned photograph of a section where an OCA adhesive is separated from a flexible film in the related art;

FIG. 4 is a diagram of steps of a method for manufacturing a flexible touch sensor according to an embodiment of the present disclosure;

FIG. 5 is a diagram of steps of a method for manufacturing a flexible touch sensor according to an embodiment of the present disclosure;

FIG. 6 is a diagram of steps of a method for manufacturing a flexible touch sensor according to an embodiment of the present disclosure;

FIG. 7 is an optical simulation graph of an index margin and an electrode in a flexible touch sensor according to an embodiment of the present disclosure; and

FIG. 8 is a connection diagram of electrodes in a flexible touch sensor and transparent bridge electrodes according to an embodiment of the present disclosure.

### DETAILED DESCRIPTION

Technical solutions in the embodiments of the present disclosure will be clearly and completely described below with reference to the accompanying drawings in the embodiments of the present disclosure. Obviously, the described embodiments are merely a part of the embodiments of the present disclosure instead of all the embodiments. All other embodiments obtained by a person of ordinary skill in the art based on the embodiments of the present disclosure without any creative work shall fall within the protection scope of the present disclosure.

It should be understood that, unless otherwise defined, all terms (including technical and scientific terms) used in the embodiments of the present disclosure have the same meanings as those commonly understood by those skilled in the art to which the present disclosure pertains. It should also be understood that terms such as those defined in a typical dictionary should be construed as having the same meanings as those in the context of the related art, and should not be interpreted in an idealized or overly formal sense unless explicitly defined here.

For example, terms such as “first,” “second,” etc., as used in the description and claims of this patent application, do not denote any order, quantity, or importance, but are only used to distinguish between different components. Words such as “including” or “comprising” etc. are used to mean that the presence of an element or item preceding the word encompasses any element or item listed after the word or equivalents thereof, and does not exclude other elements or items. Terms such as “up/upper”, “down/lower”, “one side”, “the other side”, etc. for indicating orientation or positional relationships are based on orientation or positional relationships shown in the accompanying drawings, and are merely simplified description for the convenience of explanation of the technical solutions of the present disclosure, instead of indicating or implying that the designated apparatus or element must have a specific orientation or must be constructed and operated in a specific orientation, and therefore should not be construed as limiting the present disclosure.

A touch sensor is usually made of an ITO transparent conductive material. At present, a square resistance of commonly-used ITO is 100Ω/□ (the symbol “□” represents a square), and in order to reduce an in-plane square resistance, a square resistance of ITO needs to be reduced to about 30Ω/□ with a corresponding thickness of about 135 nm (1350 Å).

It can be seen from the expression of the square resistance that, in a case of constant resistivity p, in order to achieve a process of realizing a low channel impedance of a touch sensor, as a square resistance of a trace is much less than an in-plane square resistance of a display area, it needs to increase coating power for ITO coating so as to increase a film thickness to reduce the square resistance.

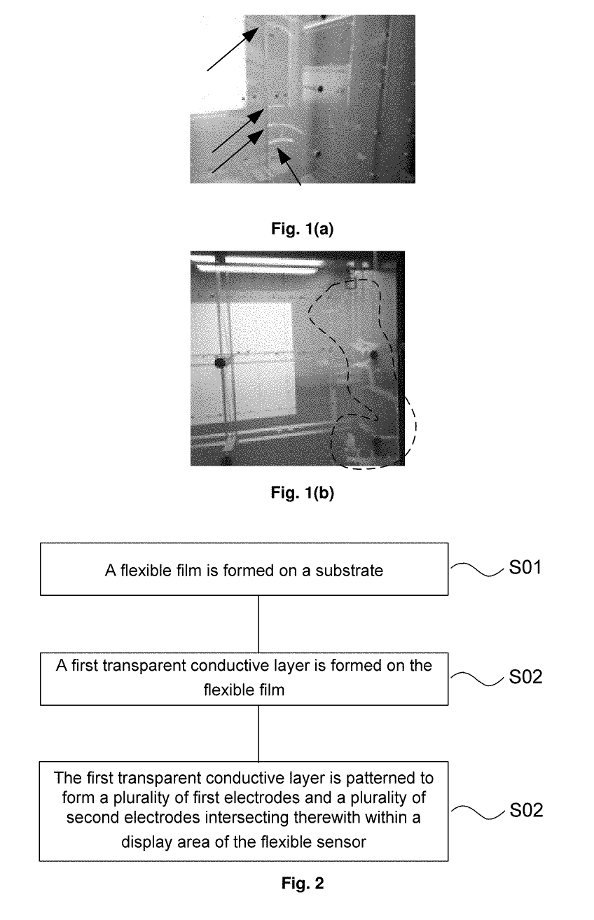

However, after the coating power is increased, as an ITO layer with a relatively large thickness is directly formed by coating once, a stress distribution in film layers is inhomogeneous, and there is a region with a large local stress. After an Over Coat (OC for short) covering the ITO is subsequently formed, bar-shaped bubbles as indicated by arrows in FIG. 1(a) appear, or bar-shaped bubbles in a dashed block in FIG. 1(b) appear. After a bubbling defect occurs on a surface of the flexible film, when a yellow light process (i.e., a photoresist process) is performed on the surface of the flexible film, as the surface of the flexible film is uneven, after the photoresist is applied to the surface of the flexible film, normal exposure area identification cannot be performed, which results in that the yellow light process cannot be performed, and the entire sensor is scrapped with a yield rate of 0%, thereby seriously affecting the good yield.

The embodiments of the present disclosure provide a method for manufacturing a flexible touch sensor, a flexible touch sensor, and a display screen including the flexible touch sensor, which can improve the problem of the inhomogeneous stress in the film layers of the electrodes while reducing the square resistance of the electrodes, thereby avoiding the problem of the bubbling defect in the subsequently formed over coat and improving the product yield.

FIG. 2 is a schematic flowchart of a method for manufacturing a flexible touch sensor according to an embodiment of the present disclosure. As shown in FIG. 2, the method comprises the following steps.

In step S01, a flexible film is formed on a substrate.

In step S02, a first transparent conductive layer is formed on the flexible film.

In step S03, the first transparent conductive layer is patterned to form a plurality of first electrodes and a plurality of second electrodes intersecting therewith within a display area of the flexible touch sensor. The first transparent conductive layer is composed of multiple layers of first transparent conductive films which are formed by deposition many times.

It should be illustrated that, when the flexible touch sensor according to the embodiments of the present disclosure is manufactured, a mother board including a plurality of flexible touch sensors may be manufactured, and then the mother board may be divided into a plurality of small pieces, i.e., individual flexible touch sensors, each of which comprises a display area, so as to enable mass production of the flexible touch sensors.

Secondly, the flexible film may have, for example, a flexible optical film material such as Cycloolefin Polymer (COP), Triacetate Cellulose (TAC), Polyethylene Terephthalate (PET), Polycarbonate (PC), Polymethyl Methacrylate (PMMA), Polyimide (PI), and TCTF etc., which is not limited in the embodiments of the present disclosure.

Before the step S02 is performed, a Hard Coating (HC) layer may be firstly formed on a surface of the flexible film to enhance hardness and scratch resistance of the flexible film and improve the operational performance of the formed flexible touch sensor.

Further, the first transparent conductive layer is formed by coating using deposition at a low temperature many times. The first transparent conductive film may be made of a transparent conductive material such as ITO, Indium Zinc Oxide (IZO), or Fluorine-Doped Tin Oxide (FTO). The deposition at a low temperature prevents a high temperature from adversely affecting the flexible film. A specific material and a specific temperature at which deposition is performed are not limited in the embodiments of the present disclosure.

Here, as the first layer of first transparent conductive film is firstly deposited on the flexible film, the formed film layer has a relatively large stress and is relatively prone to an inhomogeneous stress phenomenon. Therefore, the deposited first layer of first transparent conductive film is controlled to have a thickness of 15-45 nm, which is small, and a corresponding coating power is also small to reduce the stress of the formed first layer of first transparent conductive film.

In addition, a film layer with a good structure and less internal defects can further be obtained by reducing the coating power, which is advantageous to the optimization of electrical properties of subsequently formed electrodes (which comprise first electrodes and second electrodes).

At the same time, the finally formed multiple layers of first transparent conductive films are controlled to have a total thickness of 120-200 nm, which is large, and square resistances of the first electrodes and the second electrodes which are formed by patterning are also relatively small, which satisfies the performance requirements for a lower channel impedance of the electrodes currently required for touch products, so as to improve the sensitivity of Integrated Circuits (ICs) such as touch drivers and save the energy consumption.

Here, a thickness range of the first layer of first transparent conductive film may correspond to any value in the above-mentioned total thickness range of the multiple layers of first transparent conductive films. For example, when the first layer of first transparent conductive film has a thickness of 15 nm, the total thickness may be 120 nm or 200 nm, or any other value of 120-200 nm.

In addition, the plurality of formed first electrodes and the plurality of formed second electrodes intersecting therewith are touch driving electrodes (Tx) and touch sensing electrodes (Rx). Specific patterns of the electrodes may be the same as those in the related art, which is not limited in the embodiments of the present disclosure.

Based thereon, in the manufacturing method according to the embodiments of the present disclosure, the first electrodes and the second electrodes for realizing touch are formed by deposition many times, the deposited first layer of first transparent conductive film is controlled to have a thickness of 15-45 nm and the deposited multiple layers of first transparent conductive films is controlled to have a total thickness of 120-200 nm. In this way, the concentration degree of stress in the formed electrodes with a larger thickness is reduced while realizing a low square resistance of the electrodes, which avoids the severe bubbling defect after the subsequently formed layer is covered on the first electrodes and the second electrodes, thereby reducing the impact on the subsequent manufacturing processes and improves the product yield.

Further, in the related art, as the flexibility of the flexible film is relatively large and it is difficult to directly perform a coating process thereon, the flexible film is usually affixed to a surface of a rigid substrate such as glass via Optically Clear Adhesive (OCA) glue and then subsequent manufacturing processes are performed.

The OCA glue refers to special adhesive for cementing transparent optical elements.

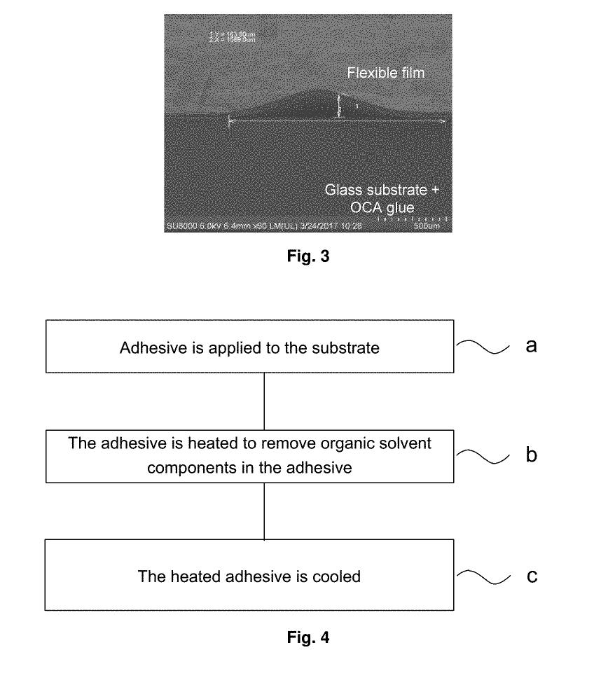

As organic solvent in the OCA glue is easy to vaporize, the OVA glue formed on the surface of the glass substrate is easily separated from the flexible film due to the influence of vaporization of water vapor in the subsequent manufacturing processes, thereby resulting in bubbles as shown in FIG. 3, which aggravates the degree of the bubbling defect after the subsequent OC manufacturing process.

Therefore, before performing the above step S01, the embodiments of the present disclosure further comprise the following steps, as shown in FIG. 4.

In step a, adhesive is applied to the substrate.

In step b, the adhesive is heated to remove organic solvent components in the adhesive.

In step c, the heated adhesive is cooled. Then, the flexible film is affixed to the adhesive.

In this way, the adhesive is annealed at a high temperature before the flexible film is affixed, which can sufficiently remove the organic solvent in the adhesive material itself to achieve the purpose of minimum of outgas after the adhesive is affixed to the flexible film.

The temperature at which the heating process is performed is preferably 150-200° C., so that the organic solvent in the adhesive is sufficiently vaporized within this temperature range; and the time during which the heating process is performed is preferably 30-60 min, so that the organic solvent can be sufficiently vaporized for removal after the organic solvent is gasified.

After that, a roll-to-sheet process may be performed to cut a roll of flexible films to a corresponding size, and the adhesive is affixed to a surface of, for example, a glass substrate to perform the above-mentioned subsequent manufacturing processes.

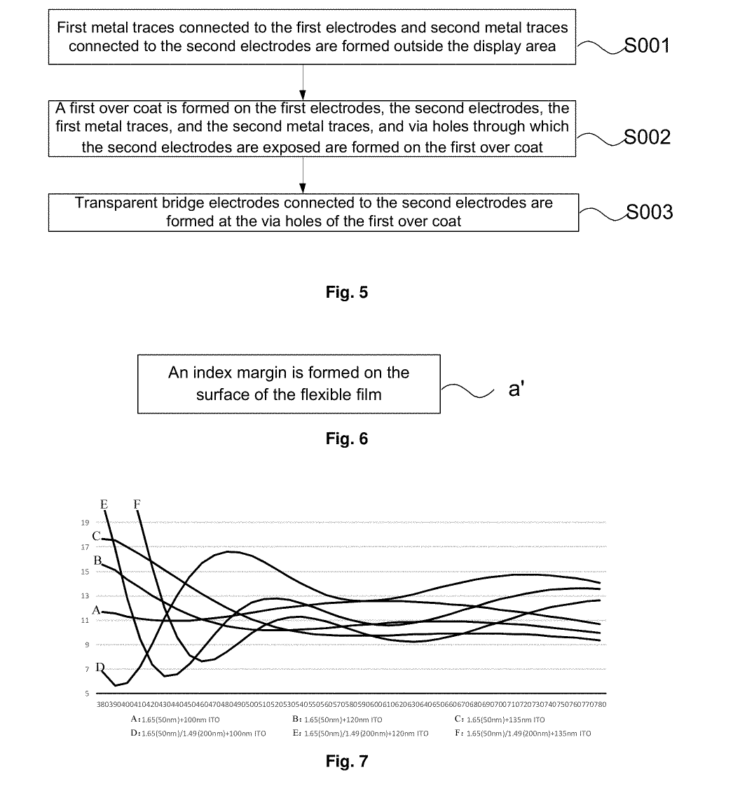

Based thereon, as shown in FIG. 5, the method for manufacturing a flexible touch sensor according to the embodiments of the present disclosure further comprises the following steps.

In step S001, first metal traces connected to the first electrodes and second metal traces connected to the second electrodes are formed outside the display area.

In step S002, a first over coat (i.e., a bridge insulating layer) is formed on the first electrodes, the second electrodes, the first metal traces, and the second metal traces, and via holes through which the second electrodes are exposed are formed on the first over coat.

In step S003, transparent bridge electrodes connected to the second electrodes are formed at the via holes of the first over coat.

It should be illustrated that, as the first electrodes and the second electrodes are formed by deposition many times, the thicknesses of the deposited film layers are controlled, so that the concentration degree of stress in the formed electrodes with a larger thickness is reduced while realizing a low square resistance of the electrodes, which avoids the severe bubbling defect after the subsequently formed film layer (i.e., the first over coat in the step S002) is covered on the first electrodes and the second electrodes.

Secondly, the metal traces may be made of materials such as Copper (Cu), Argentine (Ag) etc. having a relatively small thickness and excellent ductility (i.e., flexibility and bendability), and are patterned to form edge traces, which are connected to the first electrodes and the second electrodes respectively to provide the electrodes with corresponding touch signals.

In addition, specific patterns and arrangements of the formed first metal traces, second metal traces, via holes, and transparent bridge electrodes are not limited in the embodiments of the present disclosure.

Further, as the patterns of the first electrodes and the second electrodes are formed on the flexible film, there is a certain visual contrast between a region with an electrode and a region without an electrode, which affects the display quality. Therefore, the embodiments of the present disclosure preferably further comprise the following steps as shown in FIG. 6 before the step S01 described above is performed.

In step a′, an index margin (IM for short) is formed on the surface of the flexible film.

In this way, the subsequent first transparent conductive layer is formed on the above-mentioned index margin.

The index margin is a transition layer formed between the substrate and transparent electrodes such as ITO, so that after the ITO is etched to form patterns of the electrodes, a difference ΔR % between reflectivity before the ITO layer is etched and reflectivity after the ITO layer is etched is less than 0.5% to reduce the visual contrast between an ITO region and a non-ITO region. Thereby, etched patterns of ITO of a capacitive screen seen by human eyes have a faded color and cannot be seen under normal light, which has the effect of eliminating the patterns.

Here, the index margin is generally formed as a whole on the surface of the flexible film by coating to simplify the manufacturing process.

Further, since the first electrodes and the second electrodes have an increased thickness and a reduced square resistance, as the square resistance decreases, the blanking effect of the index margin decreases, and the reflectivity of the flexible touch sensor in the visible light region should be less than 12% to ensure the blanking effect.

In an implementation, the index margin has a dual-layer structure comprising a first optical layer and a second optical layer, wherein the first optical layer is immediately adjacent to the surface of the flexible film. The first optical layer has a refractive index of 1.65 and a thickness of 40-50 nm, and the second optical layer has a refractive index of 1.49 and a thickness of 160-200 nm. Therefore, the blanking effect of the index margin is improved by using the principle of interference cancellation with high and low refractive indexes.

In another implementation, the index margin uses a single-layer structure with a high refractive index, wherein the index margin has a refractive index of 1.65 and a thickness of 40-50 nm.

FIG. 7 illustrates optical curve simulation results for the above two implementations.

By taking the first electrodes and the second electrodes mentioned above being ITO electrodes as an example, curves A-C are reflection effects of a structure using a single-layer index margin+an ITO layer in the visible light region. It can be seen from the curve A that a structure using an index margin with a refractive index of 1.65 (a thickness of 50 nm) and ITO with a thickness of 100 nm has low reflectivity in the entire visible light region, and the blanking effect is relatively optimal. As the thickness of the ITO increases, the square resistance decreases, and for the curve B of a structure using the index margin with a refractive index of 1.65 (a thickness of 50 nm) and ITO with a thickness of 120nm and the curve C of a structure using the index margin with a refractive index of 1.65 (a thickness of 50 nm) and ITO with a thickness of 135nm, a band with small reflectivity in the visible light region gradually becomes narrower, that is, the blanking effect slightly decreases with respect to the structure of curve A.

The curves D to F are reflection effects of a structure using a dual-layer index margin+an ITO layer in the visible light region. With the same structure of the index margin, as a thickness of the ITO increases, for respective structures represented by the curves D, E, and F, a band with small reflectivity in the visible light region gradually becomes narrower, that is, the blanking effect slightly decreases with respect to the single-layer structure.

In the embodiments, considering that if a number of times of deposition of the film layers is too large, the production efficiency may be reduced, in order to improve the production efficiency while reducing the square resistance, specific parameters of the film layers which are formed by deposition many times are preferably selected so that the first transparent conductive layer is composed of two layers of first transparent conductive films which are formed by deposition twice. The formed second layer of first transparent conductive film has a thickness of 90-120 nm, and the formed two layers of first transparent conductive films has a total thickness of, for example, 45 nm+90 nm, that is, 135 nm. Alternatively, the first transparent conductive layer is composed of three layers of first transparent conductive films which are formed by deposition three times. Each layer of first transparent conductive film has a thickness of 45 nm. At present, it has been experimentally verified that there is no bubble on the over coat after coating three times with a thickness of 45 nm each time, and a good performance is achieved.

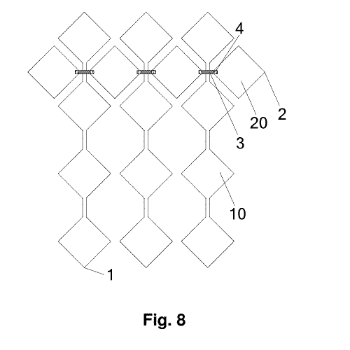

As shown in FIG. 8, each first electrode 1 formed comprises a plurality of sequentially connected first sub-electrodes 10; and each second electrode 2 formed comprises a plurality of second sub-electrodes 20 spaced apart by the first electrodes 1. Each transparent bridge electrode 3 formed is connected to two adjacent second sub-electrodes 20 in an underlying second electrode 2 through via holes 4.

In the embodiments, the first sub-electrodes 10 and the second sub-electrodes 20 may have a shape comprising, but not limited to, a diamond as shown in the figure, and may also have other shapes such as a circle.

Further, the flexible film is made of an organic material which has a large thermal expansion coefficient, and the transparent conductive material of which the first electrodes and the second electrodes are made is an inorganic material and has a small thermal expansion coefficient. If a temperature at which the first over coat is formed is too high, as thermal expansion coefficients of two underlying materials are considerably different from each other, the film layers of the first electrodes and the second electrodes may crack after the expansion of the flexible film. Therefore, in the embodiments, the first over coat is formed at a low temperature, that is, a temperature in an oven when the first over coat is formed is preferably 90-130° C.

Based thereon, in the embodiments, an over coat, i.e., a second over coat, is further needed to be formed on the transparent bridge electrodes, and a coating process of the transparent bridge electrodes should also be the same multi-deposition process as the above-mentioned step S02, so as to improve the stress problem of the film layers. That is, the second transparent conductive layer formed on the first over coat is patterned to form the transparent bridge electrodes connected to the second electrodes at the via holes. The second transparent conductive layer is composed of multiple layers of second transparent conductive films which are formed by deposition many times. A first layer of second transparent conductive film has a thickness of 15-45 nm, and the multiple layers of second transparent conductive films has a total thickness of less than 200 nm.

In an example, the second transparent conductive layer is composed of two layers of second transparent conductive films which are formed by deposition twice, and a second layer of second transparent conductive film has a thickness of 90-120 nm. In another example, the second transparent conductive layer is composed of three layers of second transparent conductive films which are formed by deposition three times, and each layer of second transparent conductive film has a thickness of 45 nm.

Similarly, a temperature at which the second over coat is formed is preferably 90-130° C., so as to prevent the film layers of the transparent bridge electrodes from cracking.

According to the manufacturing method according to the embodiments of the present disclosure, the flexible film may be separated from the adhesive according to the characteristics of the adhesive. For example, the flexible film formed with structures such as the above-mentioned electrodes, traces etc. may be processed at a low temperature, for example, 0-5° C., so as to separate the flexible film from the adhesive.

The embodiments of the present disclosure further provide a flexible touch sensor manufactured by the above-mentioned manufacturing method. A relatively flat surface may be obtained while a lower channel impedance of the electrodes is realized, and it is the first in the industry to implement a roll-to-sheet process for realizing a low square resistance.

In the practical manufacturing process, after a motherboard including a plurality of flexible touch sensors is formed, the motherboard is cut to a desired size of a flexible touch panel.

The embodiments of the present disclosure further provide a display screen including a display panel and the above-mentioned flexible touch sensor provided on a display side of the display panel.

In the manufacturing method according to the embodiments of the present disclosure, the first electrodes and the second electrodes for realizing touch are formed by deposition many times, the first layer of first transparent conductive film is controlled to have a thickness of 15-45 nm and the deposited multiple layers of first transparent conductive films are controlled to have a total thickness of 120-200 nm. In this way, the concentration degree of stress in the formed electrodes with a larger thickness is reduced while realizing a low square resistance of the electrodes, which avoids the severe bubbling defect after the subsequently formed film layer is covered on the first electrodes and the second electrodes, thereby reducing the impact on the subsequent manufacturing processes and improves the product yield.

An Organic Light-Emitting Display (OLED) device are filled with electrons and holes to realize energy level transition of electrons for light emission, belongs to an autonomous light emitting display device, and achieves a better effect of flexible display without a backlight source. Therefore, the above display panel is preferably an OLED display panel.

The foregoing description is merely specific implementations of the present disclosure, and the protection scope of the present disclosure is not limited thereto. Changes or substitutions which are easily reached by any person skilled in the art within the technical scope disclosed by the present disclosure should be within the protection scope of the present disclosure. Therefore, the protection scope of the present disclosure should be based on the protection scope of the claims.

I/We claim:

1. A method for manufacturing a flexible touch sensor, comprising:
forming a flexible film on a substrate;
forming a first transparent conductive layer on the flexible film; and
patterning the first transparent conductive layer to form a plurality of first electrodes and a plurality of second electrodes intersecting therewith within a display area of the flexible touch sensor,
wherein the first transparent conductive layer is composed of multiple layers of first transparent conductive films which are formed by multiple depositions.

2. The method according to claim 1, wherein a first layer of the multiple layers of first transparent conductive films has a thickness of 15-45 nm, and the multiple layers of first transparent conductive films have a total thickness of 120-200 nm.

3. The method according to claim 1, wherein:
the first transparent conductive layer is composed of two layers of first transparent conductive films which are formed by two depositions, wherein a first layer of the first transparent conductive films has a thickness of 15-45 nm, and a second layer of the first transparent conductive films has a thickness of 90-120 nm.

4. The method according to claim 1, wherein the first transparent conductive layer is composed of three layers of first transparent conductive films which are formed by three depositions, wherein each layer of the first transparent conductive films has a thickness of 45 nm.

5. The method according to claim 1, wherein before forming the flexible film on the substrate, the method further comprises:
applying adhesive to the substrate;
heating the adhesive to remove organic solvent components in the adhesive; and
cooling the heated adhesive.

6. The method according to claim 5, wherein forming the flexible film on the substrate comprises:
affixing the flexible film to the adhesive.

7. The method according to claim 5, wherein the heating process is performed at a temperature of 150-200° C. for 30-60 min.

8. The method according to claim 1, wherein before forming the first transparent conductive layer on the flexible film, the method further comprises:
forming an index margin on a surface of the flexible film.

9. The method according to claim 8, wherein forming the first transparent conductive layer on the flexible film comprises forming the first transparent conductive layer on the index margin.

10. The method according to claim 8, wherein the flexible touch sensor has reflectivity less than 12% in a visible light area.

11. The method according to claim 8, wherein the index margin has a refractive index of 1.65 and a thickness of 40-50 nm.

12. The method according to claim 8, wherein
the index margin comprises a first optical layer and a second optical layer, wherein the first optical layer has a refractive index of 1.65 and a thickness of 40-50 nm, and the second optical layer has a refractive index of 1.49 and a thickness of 160-200 nm.

13. The method according to claim 1, further comprising:
forming first metal traces connected to the first electrodes and second metal traces connected to the second electrodes outside the display area;
forming a first over coat on the first electrodes, the second electrodes, the first metal traces and the second metal traces, wherein via holes through which the second electrodes are exposed are formed on the first over coat; and
forming transparent bridge electrodes connected to the second electrodes at the via holes of the first over coat.

14. The method according to claim 13, wherein the first over coat is formed at a temperature of 90-130° C.

15. The method according to claim 13, wherein forming transparent bridge electrodes comprises forming a second transparent conductive layer on the first over coat, and patterning the second transparent conductive layer to form the transparent bridge electrodes connected to the second electrodes at the via holes,
wherein the second transparent conductive layer is composed of multiple layers of second transparent conductive films which are formed by multiple depositions, and a first layer of the second transparent conductive has a thickness of 15-45 nm, and the multiple layers of second transparent conductive films have a total thickness less than 200 nm.

16. The method according to claim 15, wherein:
the second transparent conductive layer is composed of two layers of second transparent conductive films which are formed by two depositions, wherein a first layer of the second transparent conductive films has a thickness of 15-45 nm, and a second layer of the second transparent conductive films has a thickness of 90-120 nm.

17. The method according to claim 15, wherein:
the second transparent conductive layer is composed of three layers of second transparent conductive films which are formed by three depositions, wherein each layer of the second transparent conductive films has a thickness of 45 nm.

18. The method according to claim 13, further comprising: forming a second over coat on the transparent bridge electrodes, wherein the second over coat is formed at a temperature of 90-130° C.

19. A flexible touch sensor, wherein the flexible touch sensor is manufactured using the method according to claim 1.

20. A display screen comprising a display panel and the flexible touch sensor according to claim 19 which is provided on a display side of the display panel.
